(19) United States
(12) Patent Application Publication
(10) Pub. No.: US 2026/0321995 A1
(43) Pub. Date: Oct. 15, 2026

(54) CONDUCTOR TERMINAL

(71) Applicant: WAGO Verwaltungsgesellschaft mbH, Minden (DE)

(72) Inventor: Henry STOLZE, Bad Frankenhausen (DE)

(73) Assignee: WAGO Verwaltungsgesellschaft mbH, Minden (DE)

(21) Appl. No.: 19/643,769

(22) Filed: Apr. 9, 2026

(30) Foreign Application Priority Data
Apr. 11, 2025 (DE) 20 2025 102 010.6

(51) Int. Cl. H01R 4/2429

(52) U.S. Cl. CPC H01R 4/2429

(57) ABSTRACT

A terminal for connecting at least one cable formed with an insulating sheath and in which at least one conductor is arranged within the insulating sheath. The conductor terminal has, for each electrical conductor to be connected, an insulation displacement contact to which an electrical conductor of the cable can be connected without prior stripping via an insulation displacement process. The conductor terminal has at least one sleeve-shaped conductor receiving body, which has a conductor insertion opening for inserting the cable and which is mounted so as to be movable relative to the insulation displacement contact, and is movable from a conductor receiving position, in which the unstripped cable can be inserted into the conductor receiving body in a conductor insertion direction, to a clamping position, in which the at least one electrical conductor of the cable is connected to the insulation displacement contact by moving the conductor receiving body.

This nonprovisional application claims priority under 35 U.S.C. § 119(a) to German Patent Application No. 20 2025 102 010.6, which was filed in Germany on Apr. 11, 2025, and which is herein incorporated by reference.

### BACKGROUND OF THE INVENTION

### Field of the Invention

The invention relates to a conductor terminal for connecting at least one cable which is formed with an insulating sheath and in which at least one electrical conductor is arranged within the insulating sheath, wherein the conductor terminal has, for each electrical conductor to be connected, an insulation displacement contact to which an electrical conductor of the cable can be connected without prior stripping via an insulation displacement process, wherein the conductor terminal has at least one sleeve-shaped conductor receiving body, which has a conductor insertion opening for inserting the cable and which is mounted so as to be movable relative to the insulation displacement contact, and is movable from a conductor receiving position, in which the unstripped cable can be inserted into the conductor receiving body in a conductor insertion direction, into a clamping position, in which the at least one electrical conductor of the cable is connected to the insulation displacement contact by moving the conductor receiving body.

### Description of the Background Art

Such a conductor terminal with an insulation displacement contact is known, for example, from DE 10 2010 019 050 A1, which corresponds to US 2011/0065306. This type of insulation displacement contact, also referred to as an IDC, allows a cable to be connected without stripping; i.e., the user does not have to first remove the insulating sheath and expose a portion of the internal electrical conductor. Instead, the electrical conductor within the insulating sheath can be connected directly with the insulation displacement process.

### SUMMARY OF THE INVENTION

It is therefore an object of the present invention to provide a further improved conductor terminal.

This object is achieved, in an example, by a conductor terminal in that the conductor terminal has at least one manual actuating element for actuating the movement of the at least one conductor receiving body from the conductor receiving position to the clamping position, wherein the actuating element is designed as a component separate from the at least one conductor receiving body and, upon manual actuation, performs a movement different from the at least one conductor receiving body. As a result, the manual actuation for moving the conductor receiving body into the clamping position can be decoupled from the conductor receiving body. A particularly efficient and ergonomic actuation of the conductor receiving body can be performed by such an actuating element, which is available as an additional component. In particular, this makes it possible to realize an actuating mechanism which comprises, e.g., a mechanical transmission, so that the actuating forces to be applied by the user can be reduced, e.g., by optimizing the force application points.

The at least one insulation displacement contact can have two opposing blades between which a cutting slot is formed in which the electrical conductor can be clamped. By moving the conductor receiving body into the clamping position, the cable part arranged within the conductor receiving body can be inserted and/or pressed into the cutting slot between the blades of an insulation displacement terminal. The insulating sheath is cut open by the blades and the internal electrical conductor is electrically connected to the insulation displacement terminal.

If the conductor terminal is designed as a multipole conductor terminal, accordingly a plurality of electrical conductors can be connected to the respective insulation displacement contacts; i.e., the conductor terminal then has a plurality of insulation displacement contacts. These can be electrically connected to each other, e.g., by electrically connecting their busbar sections to one another. The individual insulation displacement contacts can also be electrically separated from one another.

A sleeve-shaped conductor receiving body is used to receive the cable to be clamped. The sleeve-shaped conductor receiving body can be designed as a completely or predominantly closed sleeve, wherein the sleeve-shaped conductor receiving body has an opening at least due to the conductor insertion opening. A feed-through opening for passing through the insulation displacement contact can also be formed in the conductor receiving body. Inside the conductor receiving body, an elongated conductor receiving chamber can be formed into which a cable can be inserted in the conductor insertion direction. The sleeve-shaped conductor receiving body can completely or predominantly surround the cable on the circumference side, at least over the majority of its longitudinal extent. When transferring the conductor receiving body from the conductor receiving position to the clamping position, the cable can be pressed into the insulation displacement contact by such a sleeve-shaped conductor receiving body. It is possible in addition to release the cable from the insulation displacement contact again when the conductor receiving body is moved from the clamping position to the conductor receiving position by the conductor receiving body.

The sleeve-shaped conductor receiving body can in particular be designed as an elongated, predominantly closed sleeve whose length, measured in the conductor insertion direction, is at least three times as great as its dimensions orthogonal to the conductor insertion direction, i.e., the width and the height (in each case relative to the external dimensions of the conductor receiving body). In particular, a conductor receiving chamber can be formed in the conductor receiving body, the length of which chamber (measured in the conductor insertion direction) is at least three times as great or at least five times as great as its internal diameter. The conductor receiving body can have thin walls extending in the conductor insertion direction, which surround the conductor receiving chamber of the conductor receiving body formed therein. The walls can have a material thickness that is less than 50% or less than 30% of the height and width of the conductor receiving body. This also emphasizes the sleeve-like design of the conductor receiving body.

For example, the at least one conductor receiving body can be mounted so as to be displaceable and can be moved from the conductor receiving position to the clamping position via a displacement movement, e.g., in a linear displacement direction. In this case, the actuating element performs a different movement than the at least one conductor receiving body. The movement of the actuating element can, e.g., be different in that it is oriented in a different displacement direction if the actuating element is designed as a displaceable actuating element, e.g., as an actuating pusher or actuating slider. The movement of the actuating element can also be a different type of movement, e.g., in that the actuating element does not perform a displacement movement, but a pivoting movement or a combined sliding-pivoting movement.

The at least one conductor receiving body can be pivotably mounted on an insulating material housing or on another component of the conductor terminal and can be moved from the conductor receiving position to the clamping position via a pivoting movement. During the pivoting movement, the conductor receiving body can be pivoted around a pivot axis. This allows a very efficient and ergonomic connection of the electrical conductor to the insulation displacement terminal. Due to the pivotability, the conductor receiving body can act like a lever, so that a leverage can be provided which allows the user to carry out the insulation displacement process with relatively little actuation force.

The pivot axis of the at least one conductor receiving body can be a fixed pivot axis, e.g., a pivot axis fixed relative to the insulating material housing, or a variable pivot axis. In the case of the variable pivot axis, the at least one conductor receiving body can be mounted, e.g., so as to be pivotable in a floating manner.

The pivot axis of the conductor receiving body can be arranged on the side of the conductor receiving body on which the conductor receiving body has the conductor insertion opening for inserting the cable. Accordingly, the manual actuation of the conductor receiving body to perform the pivoting movement can be advantageously applied to the conductor receiving body end facing away from the conductor insertion opening in order to create the greatest possible leverage .

The at least one manual actuating element can be designed as a pivotable actuating lever which executes a pivoting movement when the at least one conductor receiving body is actuated. In this way, a leverage effect of the actuating lever can be used for force transmission when the conductor receiving body is actuated.

The pivot axis of the at least one manual actuating element can be a fixed pivot axis, e.g. a pivot axis fixed relative to the insulating material housing, or a variable pivot axis. In the case of the variable pivot axis, the at least one manual actuating element can be mounted, e.g., so as to be pivotable in a floating manner.

The manual actuating element can be pivotable in a pivoting direction opposite to the pivoting direction of the conductor receiving body. This allows a compact design of the conductor terminal and a high force transmission from the actuating lever to the conductor receiving body. For example, the manual actuating element can form a toggle lever mechanism with the conductor receiving body.

The conductor terminal can have an insulating material housing, wherein the pivot axes of the conductor receiving body and of the manual actuating element are arranged in the conductor insertion direction at a distance from one another which is at least half the dimension of the insulating material housing in the conductor insertion direction. In this way, relatively large pivoting paths can be provided for the conductor receiving body and the manual actuating element while at the same time maintaining a compact design of the conductor terminal.

The insulating material housing can have a rear wall on the conductor receiving body side facing away from the conductor insertion opening, wherein the pivot axis of the manual actuating element is disposed on the rear wall. In this way, the distance between the pivot axis of the manual actuating element and the pivot axis of the conductor receiving body is maximized. The actuating forces for the user can be minimized in this way.

The at least one conductor receiving body can have a first latching element with which the at least one conductor receiving body can be latched in the clamping position on a latching element of the conductor terminal that is not disposed on the conductor receiving body. In this way, the conductor receiving body can be secured in the clamping position and cannot move out of the clamping position again unintentionally. The first latching element can be latched, e.g., to a latching element disposed on the insulating material housing, on the busbar, or on the manual actuating element.

The manual actuating element can have a second latching element, with which the manual actuating element can be latched in the clamping position on a latching element of the conductor terminal that is not disposed on the manual actuating element. The manual actuating element can also be secured in the clamping position thereby, and unintentional movement of the actuating element is thus prevented. The second latching element can be latched, e.g., to a latching element disposed on the insulating material housing, on the busbar, or on the manual actuating element.

In the clamping position, the first latching element can be latched to the second latching element. Accordingly, in the clamping position, the conductor receiving body can be latched directly with the manual actuating element. A simple design of the conductor terminal can be ensured thereby with a simultaneous secure locking of both elements, namely, the conductor receiving body and the actuating element.

The manual actuating element can have at least one force transmission section via which, upon manual actuation, an actuating force can be transmitted by the manual actuating element from the manual actuating element to the conductor receiving body at the end of the conductor receiving body, said end facing away from the conductor insertion opening. A compact power transmission mechanism with a high power transmission can be realized in this way.

The at least one force transmission section can be designed as a cam, projecting from a surface of the manual actuating element and mounted so as to be displaceable on a force receiving section of the conductor receiving body, in particular in a guide groove. This enables a secure transmission of force from the actuating element to the conductor receiving body. In addition, a force transmission characteristic curve can be provided thereby in which the force transmission increases towards the end of the actuating path in the direction of the clamping position. Alternatively, the at least one force transmission section can be designed as a guide groove on the actuating element. At least one projecting cam can then be formed on the conductor receiving body as a force receiving section, said cam being mounted so as to be displaceable in the guide groove of the actuating element. Alternatively, or in combination with the features explained above, the at least one force transmission section can only come into contact with the force receiving section during the actuating movement of the manual actuating element; i.e. the contact is only established during the actuating movement for transferring the conductor receiving body from the conductor receiving position to the clamping position and is not yet present, e.g., in the conductor receiving position.

The at least one conductor receiving body can have a slot-shaped opening for the blades of the insulation displacement contact to pass through. The blades or other parts of the insulation displacement contact can protrude through the slot-shaped opening during the insulation displacement process and in so doing receive the electrical conductor in the cutting slot. The electrical conductor is therefore largely fixed in the conductor receiving body and cannot escape during the insulation displacement process.

The conductor receiving body can be moved by manual actuation of the manual actuating element from the clamping position to the conductor receiving position, in which the cable can be removed from the conductor receiving body. Accordingly, the manual actuating element can also be used to remove, if required, the electrical conductor from the insulation displacement contact and, accordingly, from the conductor terminal. The manual actuating element therefore also causes a corresponding movement of the conductor receiving body in the opposite actuating direction.

Due to the ability to return the conductor receiving body back from the clamping position to the conductor receiving position via the manual actuating element, a cable connected to an IDC connection can be easily disconnected again.

The at least one insulation displacement contact can be designed as a one-piece structural unit which has two opposing blades, between which a cutting slot is formed in which the electrical conductor can be clamped, and a busbar section which is shaped as a flat plate. This allows simple and cost-effective manufacturing of a single-pole or multipole conductor terminal. The number of components can be significantly reduced, particularly in the case of a multipole design, and the manufacturing and assembly costs can be reduced accordingly. Advantageously, the busbar section is formed as a flat plate. This enables simple installation and fastening of the insulation displacement connection in the conductor terminal, e.g., on an insulating material housing of the conductor terminal, as well as space-saving accommodation in the insulating material housing. The conductor terminal can therefore be designed to be particularly small and compact.

The conductor terminal can have a separate sleeve-shaped conductor receiving body for each insulation displacement contact. This has the advantage that the user can connect each individual cable or each individual electrical conductor separately by actuating the conductor receiving body. Each conductor receiving body is accordingly individually assigned to a specific insulation displacement contact. Each conductor receiving body can be moved manually into the clamping position separately.

The conductor terminal can be designed as multipole connection clamp, having a plurality of insulation displacement contacts, which have two opposing blades between which a cutting slot is formed in which the electrical conductor can be clamped, and a busbar section, wherein the insulation displacement contacts are designed as a one-piece structural unit in that the busbar sections are designed as an interconnected, one-piece busbar arrangement. In this way, a simple and compact connection clamp with insulation displacement technology can be provided that is inexpensive to manufacture and easy to use.

The plurality of insulation displacement contacts may, e.g., be arranged next to one another in a row direction in the insulating housing.

The at least one insulation displacement contact can be designed to first cut open the insulating sheath via the blades when the cable is connected via the insulation displacement process, to expose a section of the internal electrical conductor, and to make electrical contact with the exposed section of the internal electrical conductor at the blades, at least in the clamping position.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor terminal in perspective sectional view;

FIG. 2 shows the conductor terminal according to FIG. 1 in a side view of the sectional plane;

FIG. 3 shows the conductor terminal according to FIG. 2 after transferring a conductor receiving body into the clamping position;

FIG. 4 shows the insulation displacement contacts of the conductor terminal in perspective view;

FIG. 5 shows a conductor receiving body of the conductor terminal according to FIG. 1 in a perspective view;

FIG. 6 shows a manual actuating element of the conductor terminal according to FIG. 1 in a perspective view;

FIG. 7 shows the conductor terminal according to FIG. 1 without the insulating material housing in a perspective view of the back;

FIG. 8 shows the conductor terminal according to in FIG. 2 without the insulating material housing in a perspective view of the back;

FIG. 9 shows an example of a conductor terminal in perspective sectional view;

FIG. 10 shows the conductor terminal according to FIG. 7 in a side view of the sectional plane;

FIG. 11 shows the conductor terminal according to FIG. 8 after transferring a conductor receiving body into the clamping position;

FIG. 12 shows a conductor receiving body of the conductor terminal according to FIG. 7 in a perspective view; and

FIG. 13 shows an actuating element of the conductor terminal according to FIG. 7 in a perspective view.

### DETAILED DESCRIPTION

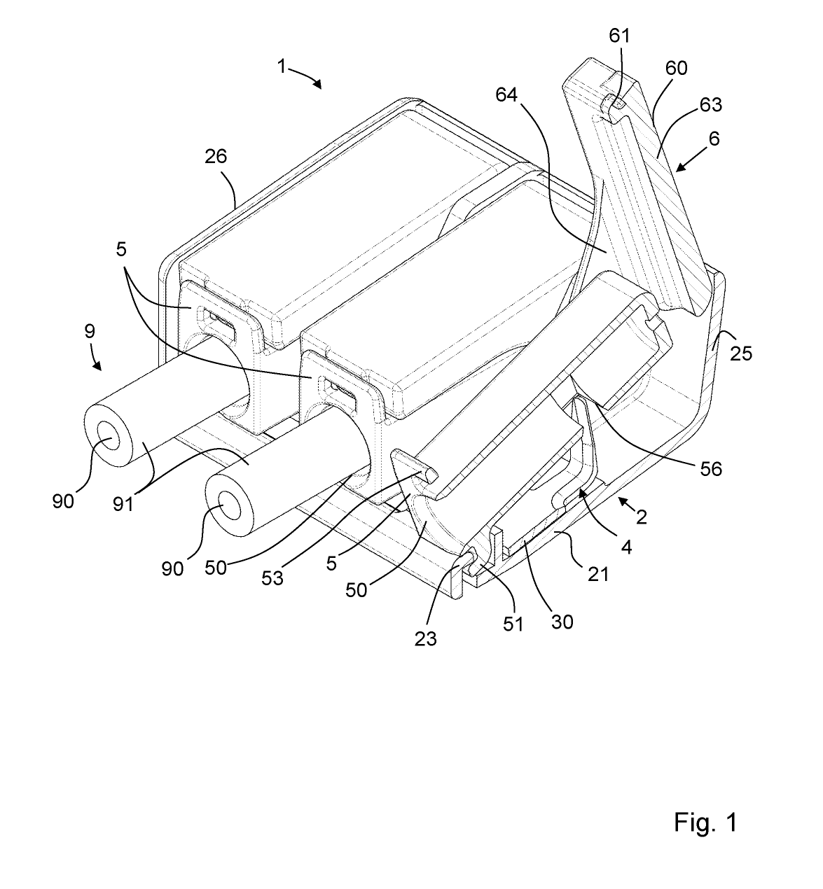

A conductor terminal 1 is illustrated in FIG. 1 and has an insulating material housing 2, e.g., a shell-shaped insulating material housing 2, which has a bottom wall 21, side walls 26, and a rear wall 25. Side walls 26 are connected to each other via bottom wall 21 and rear wall 25. Insulating material housing 2 can be designed open towards the upper side facing away from bottom wall 21 and towards the front side facing away from rear wall 25. A plurality of insulation displacement contacts 4 with their busbar sections 30 are accommodated and fastened in insulating material housing 2.

Conductor terminal 1 shown in FIG. 1 has three insulation displacement contacts 4 as an example; examples with more or fewer insulation displacement contacts 4 are also conceivable. A sleeve-shaped conductor receiving body 5 is assigned to each insulation displacement contact 4. In this case, the frontmost conductor receiving body 5, shown in section, is in the conductor receiving position, whereas the two rear conductor receiving bodies 5 are in the clamping position.

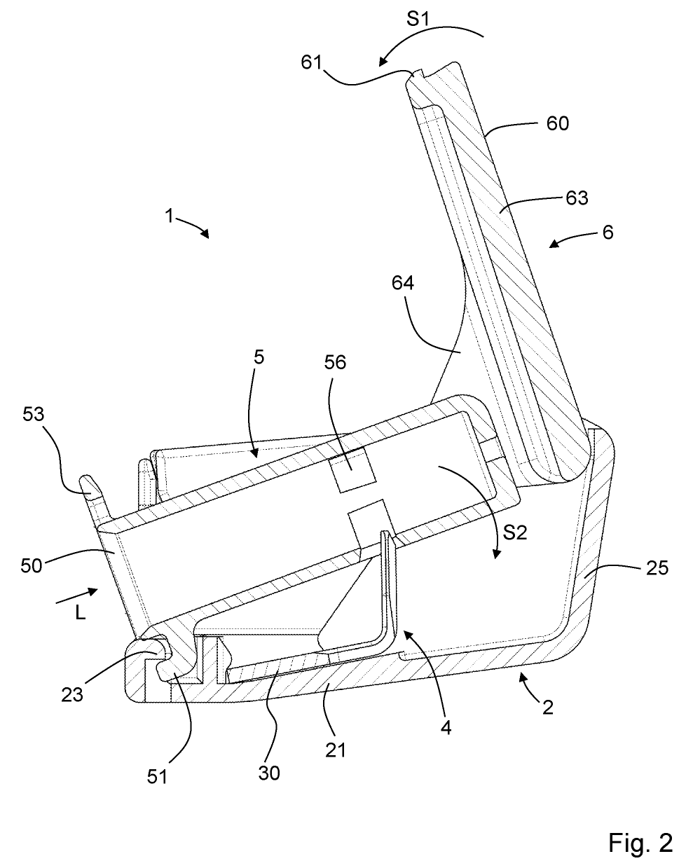

The conductor terminal according to FIG. 1 is shown in a side view of the sectional plane in FIG. 2. As can be seen, conductor receiving body 5 has a sleeve shape; i.e., within conductor receiving body 5, an elongated conductor receiving chamber is formed, into which a cable 9 can be inserted through a conductor insertion opening 50 of conductor receiving body 5 in a conductor insertion direction L. Cables 9 are formed as insulated cables, each of which has an insulating sheath 91 and an electrical conductor 90 arranged within insulating sheath 91.

At the end facing conductor insertion opening 50, conductor receiving body 5 has a bearing section 51, with which the conductor receiving body 5 can be fastened to a bearing element 23 of insulating material housing 2 and mounted so as to be pivotable. The pivot bearing of conductor receiving body 5 is thus formed by bearing section 51 together with bearing element 23, e.g., by bearing section 51, designed as an extension, engaging in bearing element 23, which is designed as an opening, and being held therein. Together with bearing section 51, bearing element 23 forms an at least substantially fixed pivot axis of conductor receiving body 5.

Conductor receiving body 5 has at least one first latching element 53, e.g., in the form of a latching bracket. First latching element 53 can, e.g., be on the side or end of conductor receiving body 5 on which conductor insertion opening 50 is located. Conductor receiving body 5 can be latched in the clamping position on a second latching element 61.

To actuate a pivoting movement of conductor receiving body 5 about the pivot axis formed by bearing element 23 and bearing section 51, conductor terminal 1 has a manual actuating element 6, individually assigned to each conductor holding body 5, in the form of a pivoting actuating lever. Actuating element 6 has a first lever arm 63 and a second lever arm 64 projecting at an angle therefrom. First lever arm 63 is used for manual actuation, e.g., by the user applying a manual actuating force to an actuating surface 60 of actuating element 6. Second latching element 61 is formed on first lever arm 63 in the area of the free end. In the clamping position, second latching element 61 can be latched with first latching element 53.

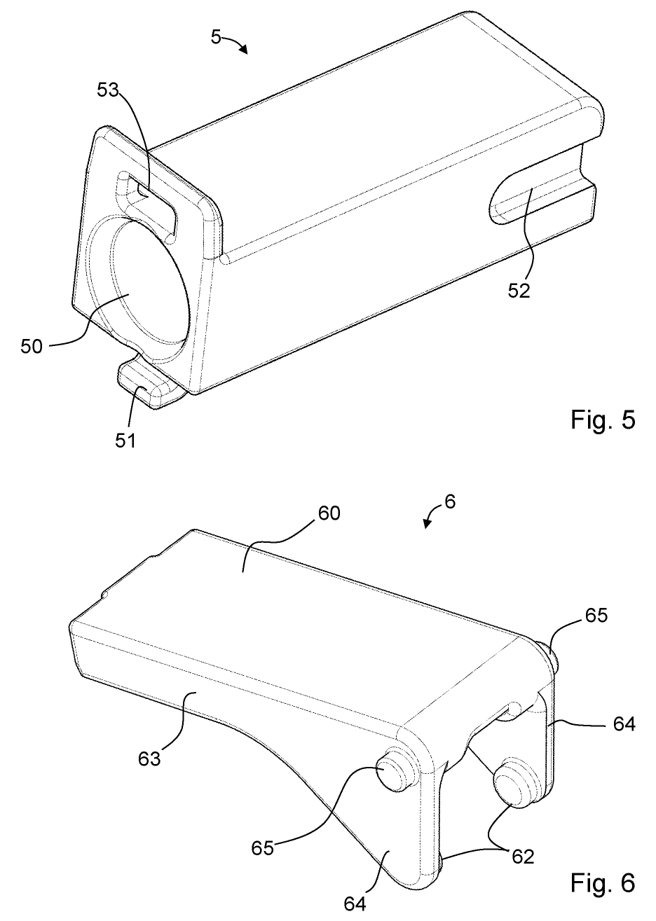

FIGS. 5 and 6 will first be used to explain the interaction between actuating element 6 and conductor receiving body 5. It can be seen that on conductor receiving body 5, on one side or on both opposite sides, in each case a force receiving section 52, e.g., in the form of a guide groove, is formed, which extends in one-piece from the end of conductor receiving body 5 facing away from conductor insertion opening 50 toward the end facing conductor insertion opening 50. Assigned to this force receiving section 52 is, in each case, a force transmission section 62 formed on actuating element 6, in particular on the inner side of second lever arm 64, e.g., in the form of a projecting cam, which, in the assembled state of the components visible in FIG. 1, is mounted so as to be displaceable in the guide groove. Actuating element 6 is designed to be rotated about a fixed axis of rotation. For this purpose, actuating element 6 has pivot bearing elements 65, e.g., in the form of laterally projecting pins, which are mounted in corresponding receiving recesses on insulating material housing 2. It is also conceivable that such pivot pins are formed on insulating material housing 2 and that corresponding recesses for receiving the pivot pins of insulating material housing 2 are formed on actuating element 6 instead of pivot pins 65. It can be seen further that actuating element 6 with its two second lever arms 64 at least partially surround conductor receiving body 5.

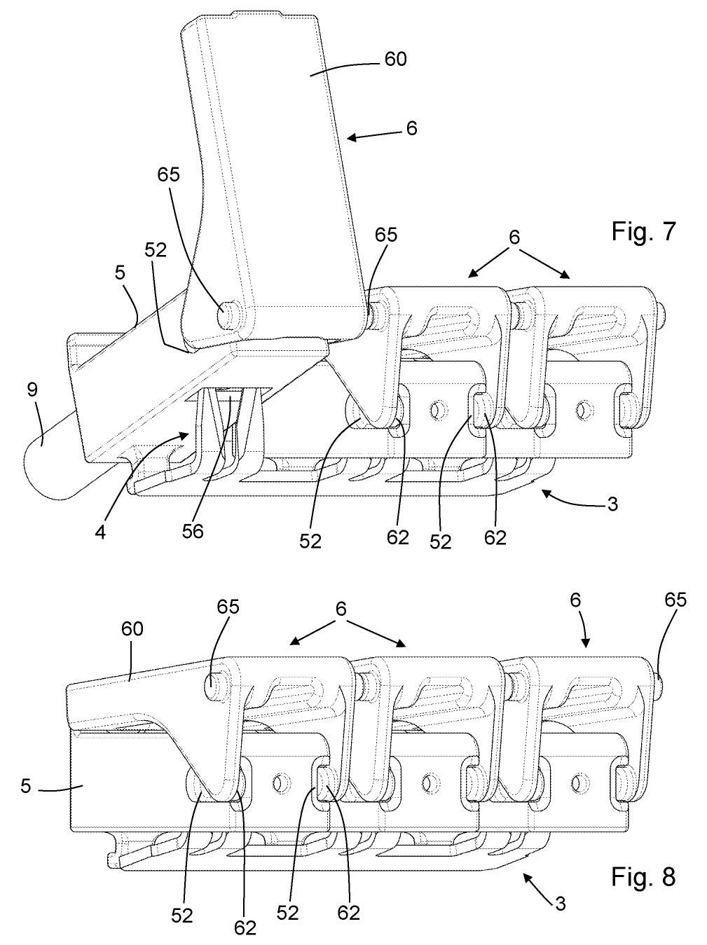

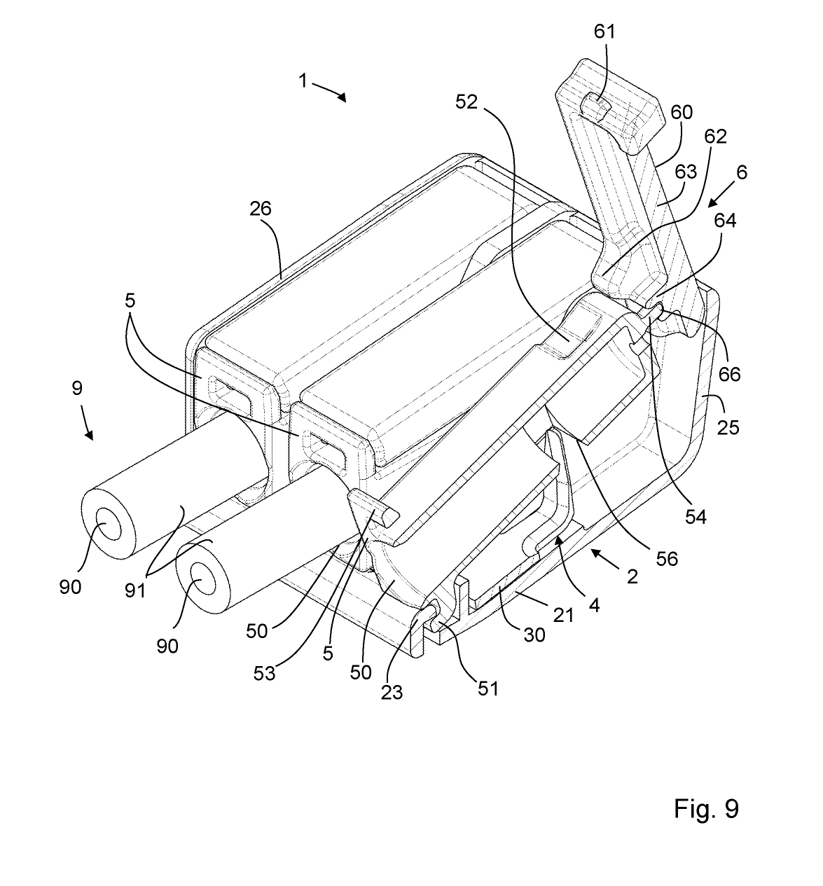

The coupling between the respective force transmission section 62 and the associated force receiving section 52 is clearly recognizable from the rear views of conductor receiving body 5 and actuating elements 6 shown in FIGS. 7 and 8. In this case, a force transmission section 62 is guided in a slot-like force receiving section 52 in the manner of a pin in a slot. FIG. 7 also illustrates the insertion of an insulation displacement contact 4 through a slot-shaped opening 56 of conductor receiving body 5 using the left conductor receiving body 5, which is in the conductor receiving position.

FIGS. 1 and 2 show conductor terminal 1 in each case with the frontmost conductor receiving body 5 shown in a sectional view and actuating element 6 in the conductor receiving position. In this conductor receiving position, actuating element 6 is pivoted relatively far out of insulating material housing 2 with its first lever arm 63. Conductor receiving body 5 is in a tilted position relative to insulating material housing 2, so that a cable 9 can be inserted into conductor receiving body 5 through conductor insertion opening 50 in a conductor insertion direction L that is slightly inclined relative to insulating material housing 2. In this position, the at least one force transmission section 62 is located in the region of the end of the respective force receiving section 52 facing conductor insertion opening 50.

To pivot conductor receiving body 5 from the shown conductor receiving position into the clamping position, actuating element 6 must be pivoted in a pivoting direction S1. This causes conductor receiving body 5 to pivot in a pivoting direction S2, which has a pivoting direction opposite to pivoting direction S1.

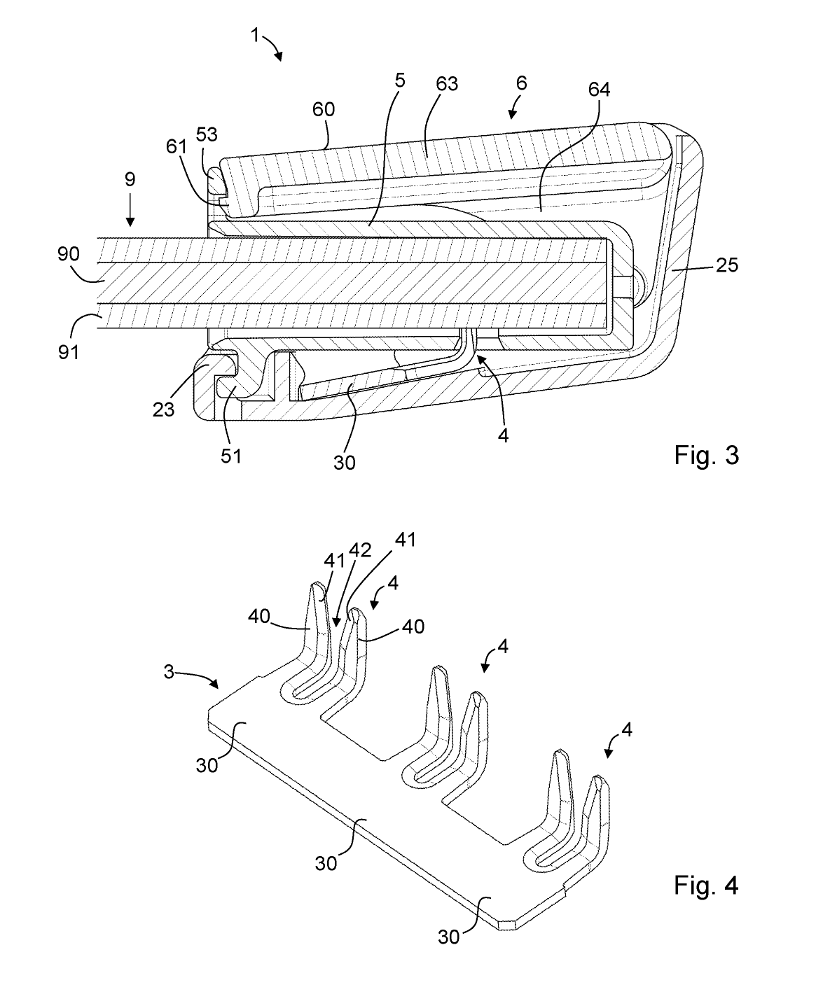

FIG. 3 shows conductor terminal 1 according to FIG. 2 after inserting a cable 9 and after pivoting conductor receiving body 5 into the clamping position. In this clamping position, the at least one force transmission section 62 is located farther back on the respective force receiving section 52, i.e., farther away from conductor insertion opening 50. It can be seen that in the clamping position, first latching element 53 is latched with second latching element 61. In this way, neither actuating element 6 nor conductor receiving body 5 can be moved back to the initial position shown in FIG. 2, at least not without deliberately releasing the latch. It can be seen further that actuating element 6 completely covers conductor receiving body 5 in the clamping position.

If the latch is released, actuating element 6 can be pivoted back again and thereby moves conductor receiving body 5 back into the conductor receiving position shown in FIG. 2 via the at least one force transmission section 62.

FIG. 4 shows insulation displacement contacts 4 together with busbar sections 30. Each insulation displacement contact 4 has two opposing blades 41, between which a cutting slot 42 is formed. In this cutting slot 42, an electrical conductor can be clamped to blades 41 or to cutting arms 40 on which blades 41 are formed. Each insulation displacement contact 4 has a busbar section 30. Cutting arms 40 of an insulation displacement contact 4 branch off from the respective busbar section 30 of insulation displacement contact 4 and are angled in relation to the substantially flat and plate-shaped busbar section 30. Cutting arms 40 with their blades 41 are formed in one piece with their respective busbar section 30, i.e., as a one-piece structural unit. In addition, busbar sections 30 are designed as a continuous busbar arrangement 3, i.e., also as a one-piece structural unit. Busbar arrangement 3 is shaped as a substantially flat plate.

FIG. 9 shows an example of a conductor terminal 1 which, apart from the differences explained below, can otherwise be constructed in the same way as the example described with reference to FIGS. 1 to 8. A difference in the example shown in FIG. 9 is the type of force transmission from actuating element 6 to conductor receiving body 5. In the conductor receiving position shown in FIG. 9 for the frontmost conductor receiving body 5, a positive-fit connection between actuating element 6 and conductor receiving body 5 is realized at the end facing away from conductor insertion opening 50 in that a projecting pin is formed on one of these components 5, 6, in this case on conductor receiving body 5, as first securing section 54 and on actuating element 6 a pin receptacle is formed as second securing section 66. However, the assignment can also be reversed; i.e., the pin can be formed on actuating element 6 and the pin receptacle on conductor receiving body 5. Second securing section 66 is disposed on second lever arm 64. First securing section 54, in cooperation with second securing section 66, secures conductor receiving body 5 in the conductor receiving position; i.e., conductor receiving body 5 is thereby held in the conductor receiving position.

On the actuating element 6, at least one force transmission section 62 is formed, which can interact with a force receiving section 52 formed on conductor receiving body 5. Force transmission section 62 can be formed as a projection, and force receiving section 52 can be formed as a trough-like recess. The assignment can also be reversed. Force transmission section 62, in cooperation with force receiving section 52, serves to transmit the actuating force for the actual insulation displacement process; i.e., the force for moving into the clamping position is transmitted via interacting elements 52, 62 on the upper side of conductor receiving body 5 and the underside of actuating element 6.

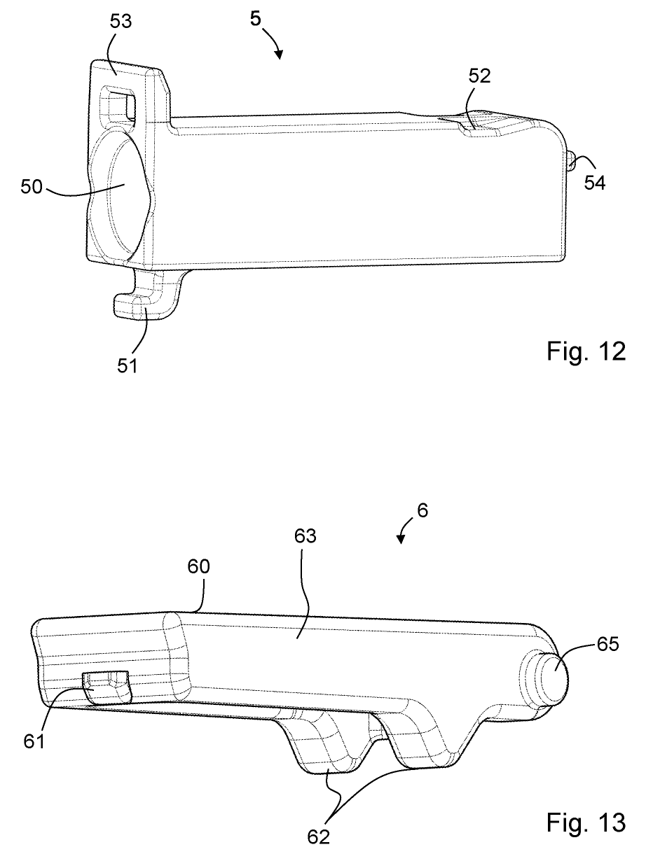

FIGS. 12 and 13 show this design of conductor receiving body 5 and actuating element 6 in additional views. A force transmission section 62 can be provided symmetrically on both sides on actuating element 6. Accordingly, a force receiving section 52 can also be formed on both sides on conductor receiving body 5. Force transmission section 62 can be shaped as a protruding hump-like elevation. Actuating lever 6 can in turn be mounted on insulating material housing 2, so that it can rotate about a fixed axis of rotation via pivot bearing elements 65.

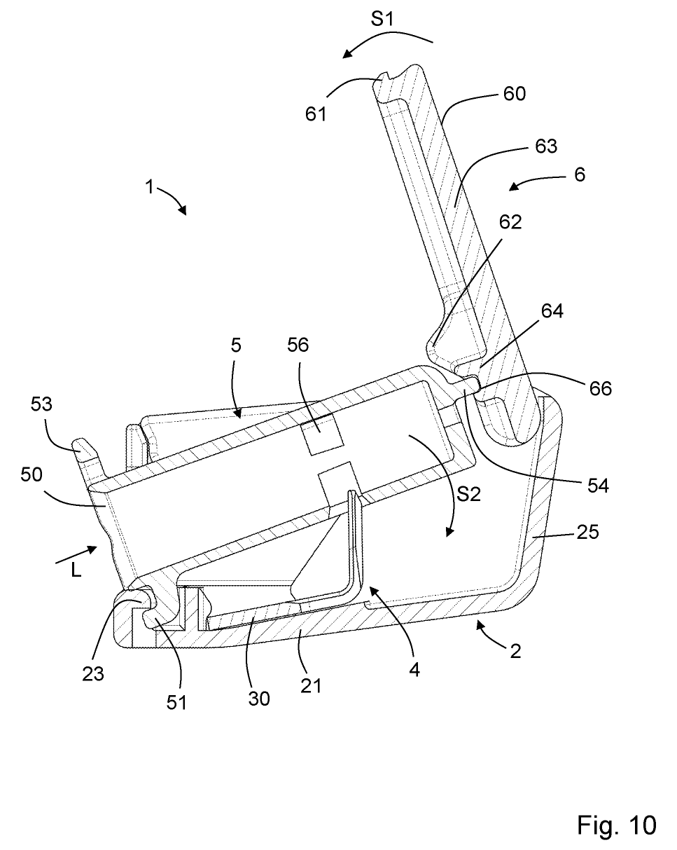

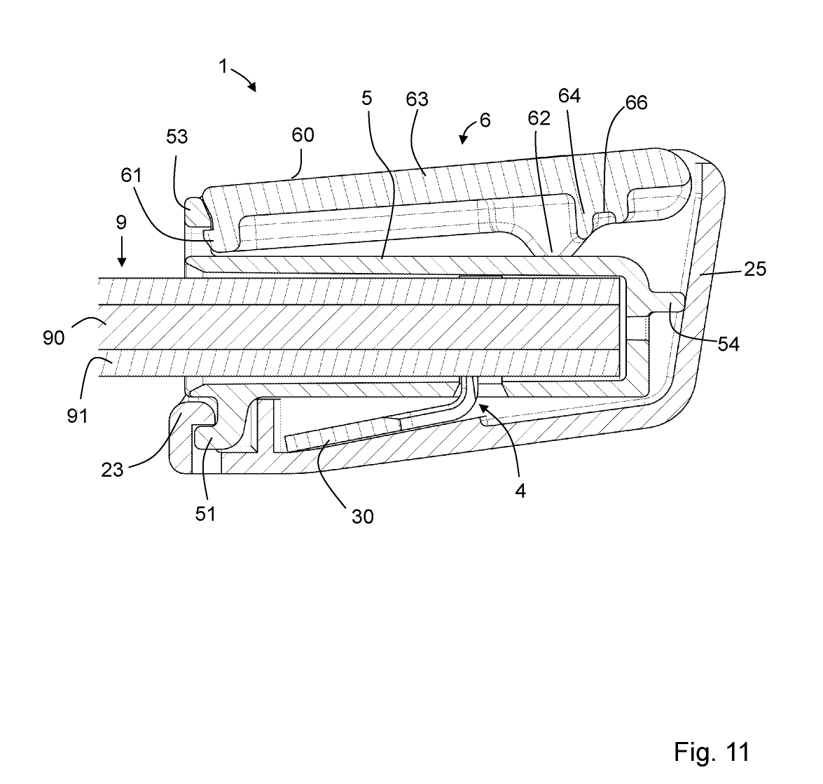

FIG. 10 shows the frontmost conductor receiving body 5 in the conductor receiving position in a depiction similar to FIG. 2. If actuating element 6 is now pivoted in pivoting direction S1, a force is first exerted on conductor receiving body 5 via the connection between first securing section 54 and second securing section 66, which causes this receiving body 5 to pivot in pivoting direction S2. During the course of this pivoting movement, the connection between first securing section 54 and second securing section 66 is released. In order to continue the pivoting movement into the clamping position, a compressive force is exerted on force receiving section 52 via the at least one force transmission section 62. This brings conductor receiving body 5 into the clamping position shown in FIG. 9. In analogy to FIG. 3, FIG. 11 also shows cable 9 clamped in the clamping position.

First latching element 53 on conductor receiving body 5 is again latched here with second latching element 61 on actuating element 6. If the latch is released in this example and actuating element 6 is pivoted back, this, however, does not lead to a movement of conductor receiving body 5, because the connection between first securing section 54 and second securing section 66 is not re-established.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal to connect at least one cable formed with an insulating sheath, in which at least one electrical conductor is arranged within the insulating sheath, the conductor terminal comprising:
an insulation displacement contact for each electrical conductor to be connected, and to which an electrical conductor of the cable is adapted to be connected without prior stripping via an insulation displacement process;
at least one sleeve-shaped conductor receiving body, which has a conductor insertion opening for inserting the cable and which is mounted so as to be movable relative to the insulation displacement contact, and is movable from a conductor receiving position, in which the unstripped cable is adapted to be inserted into the conductor receiving body in a conductor insertion direction, to a clamping position, in which the at least one electrical conductor of the cable is connected to the insulation displacement contact by moving the conductor receiving body; and
at least one manual actuating element for actuating the movement of the at least one conductor receiving body from the conductor receiving position to the clamping position, the at least one actuating element being designed as a component separate from the at least one conductor receiving body and, upon manual actuation, performs a movement different from the at least one conductor receiving body.

2. The conductor terminal according to claim 1, wherein the at least one conductor receiving body is pivotably mounted on an insulating material housing or on another component of the conductor terminal and can be moved from the conductor receiving position to the clamping position via a pivoting movement.

3. The conductor terminal according to claim 2, wherein the pivot axis of the conductor receiving body is arranged on the side of the conductor receiving body on which the conductor receiving body has the conductor insertion opening for inserting the cable.

4. The conductor terminal according to claim 1, wherein the at least one manual actuating element is designed as a pivotable actuating lever which executes a pivoting movement when the at least one conductor receiving body is actuated.

5. The conductor terminal according to claim 4, wherein the manual actuating element is pivotable in a pivoting direction opposite to the pivoting direction of the conductor receiving body.

6. The conductor terminal according to claim 4, wherein the conductor terminal has an insulating material housing, wherein the pivot axes of the conductor receiving body and of the manual actuating element are arranged in the conductor insertion direction at a distance from one another which is at least half the dimension of the insulating material housing in the conductor insertion direction.

7. The conductor terminal according to claim 6, wherein the insulating material housing has a rear wall on a side of the conductor receiving body, the side facing away from the conductor insertion opening, and wherein the pivot axis of the manual actuating element is disposed on the rear wall.

8. The conductor terminal according to claim 1, wherein the at least one conductor receiving body has a first latching element, with which the at least one conductor receiving body is adapted to be latched in the clamping position on a latching element of the conductor terminal that is not disposed on the conductor receiving body.

9. The conductor terminal according to claim 1, wherein the manual actuating element has a second latching element, with which the manual actuating element is adapted to be latched in the clamping position on a latching element of the conductor terminal that is not disposed on the manual actuating element.

10. The conductor terminal according to claim 9, wherein in the clamping position, the first latching element is adapted to be latched to the second latching element.

11. The conductor terminal according to claim 1, wherein the manual actuating element has at least one force transmission section via which, upon manual actuation, an actuating force can be transmitted by the manual actuating element from the manual actuating element to the conductor receiving body at an end of the conductor receiving body, the end facing away from the conductor insertion opening.

12. The conductor terminal according to claim 11, wherein the at least one force transmission section is designed as a cam, projecting from a surface of the manual actuating element and mounted so as to be displaceable on a force receiving section of the conductor receiving body or in a guide groove, and/or comes into contact with the force receiving section during the actuating movement of the manual actuating element.

13. The conductor terminal according to claim 1, wherein the at least one conductor receiving body has a slot-shaped opening for the blades of the insulation displacement contact to pass through.

14. The conductor terminal according to claim 1, wherein the conductor receiving body is adapted to be moved by manual actuation of the manual actuating element from the clamping position to the conductor receiving position, in which the cable is adapted to be removed from the conductor receiving body.

15. The conductor terminal according to claim 1, wherein the at least one insulation displacement contact is designed as a one-piece structural unit which has two opposing blades, between which a cutting slot is formed in which the electrical conductor is adapted to be clamped, and a busbar section which is shaped as a flat plate.

16. The conductor terminal according to claim 1, wherein the conductor terminal has a separate sleeve-shaped conductor receiving body for each insulation displacement contact.

17. The conductor terminal according to claim 1, wherein the conductor terminal is designed as a multipole connection terminal, which has a plurality of insulation displacement contacts, which have two opposing blades, between which a cutting slot is formed, in which the electrical conductor is adapted to be clamped, and a busbar section, and wherein the insulation displacement contacts are designed as a one-piece structural unit in that the busbar sections are designed as an interconnected, one-piece busbar arrangement.

18. The conductor terminal according to claim 17, wherein the plurality of insulation displacement contacts are arranged next to one another in a row direction in the insulating material housing.

19. The conductor terminal according to claim 1, wherein the at least one insulation displacement contact is designed to first cut open the insulating sheath via the blades when the cable is connected via the insulation displacement process, to expose a section of the internal electrical conductor, and to make electrical contact with the exposed section of the internal electrical conductor at the blades at least in the clamping position.

20. A conductor terminal to connect at least one cable formed with an insulating sheath, in which at least one electrical conductor is arranged within the insulating sheath, the conductor terminal comprising:
an insulation displacement contact for each electrical conductor to be connected, to which an electrical conductor of the cable is adapted to be connected without prior stripping via an insulation displacement process;
at least one sleeve-shaped conductor receiving body, which has a conductor insertion opening for inserting the cable and which is mounted so as to be movable relative to the insulation displacement contact and is movable from a conductor receiving position, in which the unstripped cable is adapted to be inserted into the conductor receiving body in a conductor insertion direction, into a clamping position, in which the at least one electrical conductor of the cable is connected to the insulation displacement contact by moving the conductor receiving body;
at least one manual actuating element for actuating the movement of the at least one conductor receiving body from the conductor receiving position to the clamping position, and the conductor receiving body is adapted to be moved by manual actuation of the manual actuating element from the clamping position to the conductor receiving position, in which the cable is adapted to be removed from the conductor receiving body.
